(19) United States
(12) Patent Application Publication
(10) Pub. No.: US 2015/0274542 A1
(43) Pub. Date: Oct. 1, 2015

(54) MATERIALS FOR STORAGE OF FLUORINE AND CHLORINE

(71) Applicant: The Research Foundation for the State University of New York, Albany, NY (US)

(72) Inventors: Artem Oganov, East Setauket, NY (US); Qiang Zhu, Brooklyn, NY (US)

(21) Appl. No.: 14/670,535

(22) Filed: Mar. 27, 2015

Related U.S. Application Data
(60) Provisional application No. 61/971,763, filed on Mar. 28, 2014.

(51) Int. Cl. C01D 17/00; G06F 17/50; C01B 7/20

(52) U.S. Cl. CPC C01D 17/003; C01B 7/20; G06F 17/50

(57) ABSTRACT

The present disclosure relates to compounds including fluorine or chlorine, and methods for making these compounds. The compounds of the present disclosure are stable and permit long-term storage, while at the same time allowing for safely, easily and reversibly extraction of fluorine and/or chlorine therefrom.

### CROSS REFERENCE TO RELATED APPLICATIONS

This application claims the benefit of, and priority to, U.S. Provisional Patent Application Ser. No. 61/971,763, filed Mar. 28, 2014, the entire disclosure of which is incorporated by reference herein.

### BACKGROUND

The present disclosure relates to novel compounds and methods for forming these compounds. More specifically, the present disclosure provides a class of compounds containing large amounts of fluorine (F) and chlorine (Cl) that can be easily extracted, and are useful for very effective, compact and safe storage of these chemically reactive gases.

Light halogens, fluorine (F) and chlorine (Cl), exist as gases at normal conditions, and for industrial use. As toxic chemicals, they are very inconvenient for use, as their storage is very difficult. Both of these gases are highly reactive and toxic, and storage in the gaseous form (even as liquefied gases) is very inefficient. Compressed tanks possessing these gases may explode, presenting great danger.

For example, where fluorine is manufactured by electrolytic manufacture (or any other method), it can be stored in pressurized cylinders and transported to the site of use. For plants with higher F₂ demand, it may be desirable to produce the F₂ directly on site, but this may not be feasible in all instances.

At normal conditions, a volume of 22.4 liters of pure fluorine gas weighs just 36 grams, illustrating the very poor efficiency for storage in this form.

Improved methods for storing these materials remain desirable.

### SUMMARY

The present disclosure provides novel compounds including fluorine or chlorine, and methods for forming these compounds. In embodiments, compounds of the present disclosure are of the formula CsFn, wherein n is an integer selected from the group consisting of 2, 3, and 5.

Methods of the present disclosure include providing a source of CsFₙ, wherein n is an integer selected from the group consisting of 2, 3, and 5, heating the CsFₙ to a temperature from about 250° K to about 400° K; recovering F as the CsFₙ is heated; collecting CsF remaining after heating; and forming CsFₙ by adding additional F to the collected CsF. In embodiments, the heating may occur at ambient pressure.

Other methods of the present disclosure include inputting characterization information of a CsFₙ chemical structure and input parameters; generating a first generation of CsFₙ crystal structures from the characterization information using symmetrical initialization; optimizing the chemical structure of the first generation of CsFₙ crystal structures according to the input parameters; inputting the CsFₙ crystal structures of the optimized first generation into a niching algorithm to select an optimal group of CsFₙ crystal structures and a parent group of CsFₙ crystal structures based on a fitness function; producing a child group of CsFₙ crystal structures from the parent group of CsFₙ crystal structures using a variation operator; adding the child group of CsFₙ crystal structures to the optimal group of CsFₙ crystal structures to form a next generation of CsFₙ crystal structures; and repeating the optimizing through adding steps for a predetermined number of generations, wherein n is an integer selected from the group consisting of 2, 3, and 5.

Other methods of the present disclosure include methods for predicting an optimized surface structure of CsFₙ crystal structures, the method including inputting characterization information of a CsFₙ crystal structure and input parameters; generating a first convex hull of a first generation of surface structures of the CsFₙ crystal structure from characterization information using a docking algorithm; restricting the first generation of surface structures of the CsFₙ crystal structure based on a convex hull algorithm according to a user-defined chemical potential constraint and outputting a second convex hull of the first generation of surface structures of the CsFₙ crystal structure; optimizing the second convex hull of the first generation of surface structures of the CsFₙ crystal structure according to the input parameters; inputting the optimized second convex hull into a niching algorithm to select an optimal group of surface structures of the CsFₙ crystal structure and a parent group of surface structures of the CsFₙ crystal structure based on a fitness function; producing a child group of surface structures of the CsFₙ crystal structure from the parent group of surface structures of the CsFₙ crystal structure by applying a variation operator to an adatom layer of the surface structure of the first generation; adding the child group of surface structures of the CsFₙ crystal structure to the optimal group of surface structures of the CsFₙ crystal structure to form a second generation of surface structures of the CsFₙ crystal structure; and repeating the optimizing through adding steps for a predetermined number of generations, wherein n is an integer selected from the group consisting of 2, 3, and 5.

### BRIEF DESCRIPTION OF THE DRAWINGS

The accompanying drawings, which are included to provide further understanding of the subject technology and are incorporated in and constitute a part of this specification, illustrate aspects of the disclosure and together with the description serve to explain the principles of the subject technology.

The FIGURE is a convex hull diagram for the Cs-F system at zero pressure and temperature, showing the formation of numerous (meta)stable fluorine-rich compounds, including CsF₂, CsF₃, CsF₅.

### DETAILED DESCRIPTION

Annually, at least 17,000 metric tons of fluorine are produced. While it is cheap ($5-8 per kilogram) in the form of solid compounds (UF₆ and SF₆), fluorine gas is much more expensive because of difficulties associated with its storage and handling. Elemental fluorine is widely used, for example: as UF₆, used for producing nuclear fuels; as SF₆, a dielectric medium in high voltage transformers; hexafluorides of Re and W that are used in the electronics industry; and various organic fluorides (e.g. in pharmaceuticals).

Elemental chlorine has a similar volume of production and also a wide range of applications, mostly in the production of organic compounds (e.g. polyvinylchloride).

Production of these compounds would be greatly facilitated if storage of F and Cl could become safer and more efficient.

Recently, the possibility of existence of totally new and unexpected compounds at high pressures has been suggested and experimentally proven, where such compounds as NaCl₇, NaCl₃, Na₃Cl₂, Na₂Cl, Na₃Cl have been found. Methods for predicting the feasibility of these and other compounds, as well as optimized crystal structures for these compounds, include those disclosed in U.S. Patent Application Publication No. 2012/0330632, the entire disclosure of which is incorporated by reference herein.

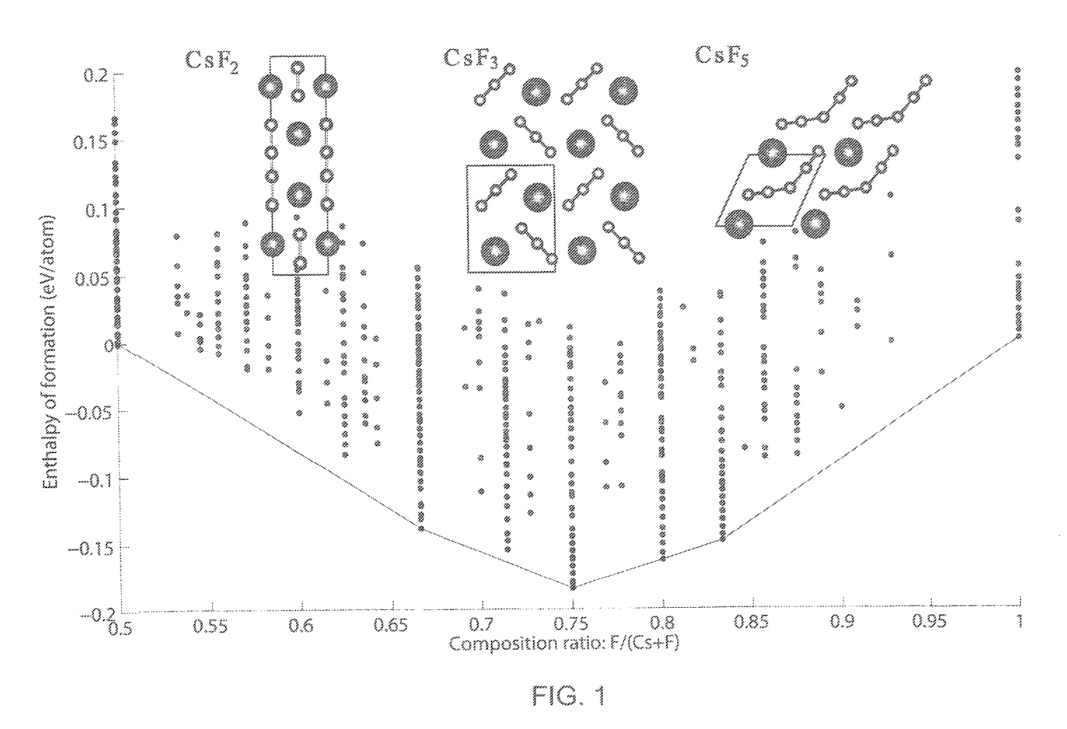

In accordance with the present disclosure heavier alkali metals are used to form compounds with fluorine or chlorine that are stable at zero pressure. Using the methods disclosed in U.S. Patent Application Publication No. 2012/0330632, KCl₃, is identified as thermodynamically stable at zero pressure and zero Kelvin temperature, with even greater stability for chlorine-rich compounds of Rb and Cs, and similarly interesting results obtained for fluorides of cesium (FIG. 1).

Briefly, the structures of the compounds of the present disclosure, utilizing the methods of U.S. Patent Application Publication No. 2012/0330632, were as follows. As disclosed therein, a variable-composition evolutionary algorithm, known as Universal Structure Predictor: Evolutionary Xtallography (USPEX), which initializes the population using randomly selected chemical compositions, with atoms placed at random within randomly selected space groups, is used. Following relaxations, the structures developed are ranked using their fitness function, and the fittest ones are allowed to produce daughter structures using crossover (heredity) and mutation operators. Compositions that are on the thermodynamic convex hull, are by definition thermodynamically stable.

More specifically, to arrive at the compounds of the present disclosure following the methods of U.S. Patent Application Publication No. 2012/0330632, characterization information of the desired chemical structure was input. The characterization information includes chemical formulae, an atomic number of an atom, a number of atoms in a unit cell, valences of atoms, and unit cell volume. The characterization information may also include lattice parameters known from experimental data and other information.

Following the inputting of characterization information, a first generation of crystal structures is obtained, preferably by a random input, seed input or symmetrical initialization. The first generation of crystal structures is generated using a symmetrical initialization algorithm based on the input characterization information. A randomly produced crystal structure can be utilized to commence generation of crystal structures, with the symmetrical initialization algorithm randomly selecting a space group compatible with the number of atoms in a unit cell of the chemical structure. For example, the space group can be randomly selected from space group numbers 1 to 230 using a Mersenne Twister algorithm. See Matsumoto, M., et al., Mersenne Twister: A 623-dimensionally Equidistributed Uniform Pseudo-Random Number Generator, ACM Transactions On Modelling and Computer Simulation, 8 (1) (1998), pp. 3-30. The space group can also be randomly selected by a random number generator algorithm. The symmetrical initialization selects from either an entire list of two hundred and thirty space groups or selects from a user-provided list of space groups. A symmetrical initialization unit cell is then configured based on the selected space group and a predetermined initial volume.

The symmetrical initialization preferably includes adding symmetrical random structures in each generation to improve population diversity and provide new crystal structures to be explored by the evolutionary algorithm. The symmetrical initialization includes unit cell splitting to provide a reduced number of degrees of freedom of the crystal structures. The symmetrical initialization introduces additional translational symmetry, i.e. pseudosymmetry, to the crystal structures. The symmetrical initialization uses up to two hundred and thirty space groups, allowing the user to produce a diverse first generation of crystal structures.

Using the symmetrical initialization algorithm, a plurality of atoms are randomly placed on separate first Wyckoff positions, herein a first position, and coordinates of each of the atoms are multiplied by space group symmetry operations. The first position of each of the atoms includes all points of a space group for which site-symmetry groups are conjugate subgroups of the space group. If an inter-atomic distance of two or more symmetry-related atoms is within a user-defined threshold, the symmetry-related atoms are merged into one atom on a second position defined by averaging of coordinates of symmetry-related atoms.

A sum of the merged atoms and remaining atoms outside of the user-defined threshold for the inter-atomic distance is compatible with the space group symmetry operation. However, discarding the merged atoms from a crystal structure of the first generation of crystal structures may be necessary if the sum is incompatible with the space group symmetry operation. New atoms are added one at a time to ensure that no atoms, including symmetrically unrelated atoms, are too closely positioned.

To obtain an exact number of atoms necessary in a unit cell, certain atoms are placed on special Wyckoff positions having a correct multiplicity. The multiplicity of the Wyckoff position refers to a number of atoms obtained after multiplying the atom in the Wyckoff position using a group symmetry element. For example, if six atoms are needed to reach the number of atoms in the unit cell, atoms are input into positions with multiplicities of 1-6, but not with a multiplicity larger than six. Otherwise, after multiplication, more atoms than are desired for the unit cell are obtained. This process of symmetrical initialization provides an unbiased procedure for sampling of each allowed space group and placing of atoms in positions that ensure minimum distances between all atoms. If symmetrically related atoms are closer than the user-defined threshold, they are merged into the second position. If symmetrically non-equivalent atoms are within a user-defined threshold for distance between atoms, the crystal structure is discarded without relaxation. The user-defined threshold is one of the user input parameters, which, in embodiments, is set to a half sum of the covalent radii of the corresponding atoms.

Local optimization of the chemical structure of the first generation of crystal structures according to the input parameters then occurs. Local optimization, i.e. relaxation, does not break individual cell symmetry, but increases symmetry of the entire supergroup. Preferably, random displacement of atomic positions provides a possibility of breaking symmetry. Variation operators are also provided to break symmetry, and to remove bias that may have been caused by the selected space group.

After optimization, the optimized first generation of crystal structures is input into a niching algorithm to select two separate groups of crystal structures from the optimized first generation of crystal structures. The niching algorithm calculates a set of conventional fitness functions and a set of fingerprint functions for each crystal structure of the first generation of crystal structures. The set of fitness functions allow the user to assess the quality of the crystal structures in the first generation of crystal structures according to a chemical property of the chemical structure that the user wants to optimize. Chemical properties include, for example, free energy, density, hardness, dielectric constant and/or bandgap. The set of fingerprint functions allows the user to assess the similarity between each of the crystal structures of optimal group of crystal structures and the parent group of crystal structures. A fingerprint function of a crystal structure is calculated according to Equation (1) found in U.S. Patent Application Publication No. 2012/0330632, reproduced below:

$${F}_{{A}_{i} B} ( R ) = {\sum }_{{B}_{j}} \frac{δ ( R - {R}_{ij} )}{4 π {R}_{ij}^{2} ( {N}_{B} / V ) Δ} - 1 , \qquad ( 1 )$$

where V is the unit cell volume, N_{B} is a number of type B atoms in the unit cell, Rᵢⱼ is inter-atomic distance between atoms Aᵢ and Bⱼ, δ(R−Rᵢⱼ) is a Gaussian-smeared delta function, which absorbs numerical errors and makes F(R) a smooth function. Gaussian smearing is controlled by an input parameter sigmaFing. F(R) is discretized over bins of width Δ to obtain a fingerprint vector FP_{A}_{ᵢ}_{B}. Bins of width Δ are preferably specified by a user as an input parameter deltaFing. The fingerprint function input parameters are preferably set as 0.03 for sigmaFing, 0.08 for deltaFing, and 8.0 for RmaxFing.

The fingerprint function of Equation (1) is provided for an individual type Aᵢ atoms relative to all Bⱼ type atoms, referred to herein as atoms Aᵢ and Bⱼ, respectively, surrounding atom Aᵢ with a sum running over all Bⱼ atoms within a distance threshold Rₘₐₓ, which preferably is user specified as an input parameter RmaxFing, with Rₘₐₓ referring to a sum over all atoms Bⱼ for which Rᵢⱼ<Rₘₐₓ.

The niching algorithm includes determining a degree of similarity between a plurality of fingerprint functions from the set of fingerprint functions, utilizing Equation (2) as described in U.S. Patent Application Publication No. 2012/0330632, reproduced below:

$${d}_{ij} = 0.5 ( 1 - \frac{{FP}_{i} {FP}_{j}}{‖ {FP}_{i} ‖ ‖ {FP}_{j} ‖} ) , \qquad ( 2 )$$

where FPᵢ is a fingerprint vector of crystal structure of Aᵢ, ∥FPᵢ∥ is a norm of the FPᵢ fingerprint vector, FPⱼ is a fingerprint vector of crystal structure of Bⱼ, and ∥FPⱼ∥ is a norm of a FPⱼ fingerprint vector. As discussed above, the fingerprint vector is a result of discretization of the fingerprint function calculated according to Equation (1).

Utilizing these equations, where identical structures are determined, only those that have a best fitness function, i.e. structures having a lowest free energy, are selected to participate in creation of child crystal structures. Since pairs of parent crystal structures cannot be fully identical, the diversity of the next population improves by employing the niching algorithm.

An optimal group of crystal structures is selected. To improve diversity when selecting the optimal group of crystal structures, a first optimal crystal structure from the parent group of crystal structures is discarded when a distance between the fingerprint function of the first optimal crystal structure and the fingerprint function of a second optimal crystal structure is smaller than a user-defined distance threshold. The user-defined threshold for the distance between the fingerprint functions of the optimal group of crystal structures is input as input parameter toleranceBestHM. However, the user-defined thresholds for the optimal group of crystal structures and the parent group of crystal structures may overlap.

Output of the niching algorithm provides an optimal group of crystal structures that survive unchanged into a next generation. The optimal group of crystal structures is selected as the first selected group, which represents crystal structures having most desirable crystal structures, i.e. structures with lowest free energy, from the optimized first generation of crystal structures.

Output of the niching algorithm also provides a parent group of crystal structures having crystal structures with a best fitness function, i.e. the lowest free energy. Crystal structures with a poor fitness function are discarded. Crystal structures that are duplicates of crystal structures within the optimal group and the parent group of crystal structures are preferably also discarded. The evolutionary algorithm may be tuned using input parameters to allow a user to optimize desired properties, including free energy, density, hardness, dielectric constant and bandgap, of the chemical structure. These input parameters include sigmaFing, deltaFing, RmaxFing, toleranceFing, toleranceBestHM, and goodBonds. Approximately sixty to seventy optional input parameters may be employed depending on the properties of the chemical structure that the user wishes to tune.

The parent group of crystal structures thus selected is output from the optimized first generation of crystal structures according to the fitness function. The parent group of crystal structures selected from the optimized first generation of crystal structures are chosen as a user defined function of the optimal group of crystal structures.

Thereafter, a child group of crystal structures are produced from the parent group of crystal structures using a variation operator that includes one of a lattice mutation operator, a coordinate mutation operator, a spatial heredity operator and an atomic permutation operator, to produce a child group of crystal structures from the parent group of crystal structures according to user-defined proportions. For example, 25% of the parent group of crystal structures will be input into each of the lattice mutation operator, the coordinate mutation operator, the spatial heredity operator, and the atomic permutation operator to produce the child group of crystal structures.

Random variation operators provide a diverse population by exploring an entire search space. Randomness ensures an unbiased search and limits genetic drift. However, completely random variation operators are typically inefficient when applied to crystal structures with a unit cell size of over forty atoms. To improve the variation operators, a local order element is introduced according to Equation (3) in U.S. Patent Application Publication No. 2012/0330632, reproduced below:

$${\prod }_{i} = \sqrt{{\sum }_{B} \frac{{N}_{B}}{N} \frac{Δ}{{( V \text{/} N )}^{1 / 3}} {\vert {F}_{{A}_{i} B} \vert}^{2}} , \qquad ( 3 )$$

where i=[1, . . . , N] denotes individual atoms in a unit cell, N is a total number of atoms in the unit cell, V is a unit cell volume, FP_{A,B} is a fingerprint vector of Aᵢ and B represents all atom types present in the unit cell. Πᵢ is the local order element for atom i and Πᵢ characterizes environment quality and atomic position symmetry, with a smaller value of Πᵢ for a given atom indicating a larger probability that the given atom will mutate.

The local order element quantifies a degree of symmetry of the environment of a given atom and also quantifies the average degree of order of a fragment of a crystal structure. Thus, the less distorted and less defective regions of the crystal structure may be input into the spatial heredity operator and more defective regions of the crystal structures may be input into the lattice mutation operator and the atomic permutation operator. When the local order element is low, a number of defects and distortion are high. Where the local order element is high, the number of defects and distortion are low. However, a value of the local order element depends on factors that include atoms involved and atomic positions. If distortions or defects are favorable, the user may select those regions of the crystal structures accordingly.

Also a plurality of slices are selected from a parent group of crystal structures in a spatial heredity operator as a function of an order-fitness function correlation coefficient. Each slice is a portion of a crystal structure formed when the crystal structure is cut along two parallel planes. All atoms located between these planes form the slice. Specifically, two parallel cuts are made through the crystal structures and the portion of crystal structure between the parallel cuts is the slice. The spatial heredity operator preferably includes generating an amount of slices of a unit cell and selects a slice from slices having a highest average order. Specifically, in the spatial heredity operator, the slices of the unit cell are selected from a plurality of crystal structures from the parent group of crystal structures and the slices are then combined to produce the child group of crystal structures. The slices selected from the parent group of crystal structures in the spatial heredity operator function as an order-fitness correlation coefficient. To improve diversity of crystal structures, a user may incorporate portions of both the less distorted and defective regions, as well as the more distorted and defective regions. To determine which portions to incorporate, correlation between the average order of the crystal structures and the fitness value of the crystal structures is calculated. Depending on the degree of correlation, the degree to which the local order element influences the variation operators is determined. When there is a positive correlation, N, attempts to cut the slices are made from each parent and the most ordered slices are selected. That is, the number of slices of the unit cell from which the slice with the highest average order is selected is determined according to Equation (4) in U.S. Patent Application Publication No. 2012/0330632, reproduced below:

$${N}_{s} = \frac{L}{{L}_{char} + ( L - {L}_{char} ) \cdot {cos ( \frac{π}{2} r )}^{2}} , \qquad ( 4 )$$

where Nₛ is the number of slices, r∈[−1;1] is a Pearson product-moment correlation coefficient, L is a thickness of a unit cell in a direction of the slice for the spatial heredity operator, and L_{char} is a length of half of a cubic root of an average atomic volume, with Nₛ rounded to the nearest integer. Thus, N, changes from a value of one in the absence of correlation (r=0) to L/L_{char} for perfect correlation

Since the user does not need an exact and computationally expensive ab initio dynamical matrix to calculate phonon modes, the dynamical matrix may be calculated from bond hardness coefficients while setting atomic masses to unity. The soft-mode mutation operator includes calculating the dynamical matrix according to Equation (5) in U.S. Patent Application Publication No. 2012/0330632, reproduced below:

$${D}_{αβ} ( a , b ) = {\sum }_{m} \frac{{\partial }^{2}}{\partial {α}_{a}^{0} \partial {β}_{b}^{m}} ( \frac{1}{2} {\sum }_{i , j , l , n} {{H}_{i , j}^{l , n} ( {r}_{i , j}^{l , n} - {r}_{{0}_{i , j}}^{l , n} )}^{2} ) , \qquad ( 5 )$$

with coefficients α, β denoting coordinates (x,y,z); coefficients a, b, i, j describing an atom in a unit cell; and coefficients l, m, n describing a unit cell number. r_{i,j}^{l,n} is a distance between atom i in the unit cell l and atom j in the unit cell n, while r_{0i,j}^{l,n} the corresponding bond distance. H_{i,j}^{l,n} is a bond hardness coefficient between the atom i in the unit cell/and atom j in the unit cell n. For example, atoms are preferably treated as point particles and bonds as springs that connect the atoms with a stiffness determined by H_{i,j}^{l,n}. Bonds with a valence strength greater than input parameter goodBonds are included in H_{i,j}^{l,n}. Eigenvectors of D_{αβ}(a,b) correspond to lowest non-zero eigenvalues and determine a direction of the soft mode mutation operator.

Valence strength is a chemical property of the bond between two atoms. A higher valence strength indicates a stronger bond between atoms. The input parameter goodbonds sets a threshold that determines which bonds are considered sufficiently strong to participate in the dynamical matrix. The dynamical matrix, as explained above, is used to calculate the eigenvectors and eigenvalues. The eigenvalue together with corresponding eigenvector is referred to as a mode. A mode having a relatively small eigenvalue is considered a soft mode in which mutation consists of movement of atoms along the eigenvector.

The child group of crystal structures that are obtained are added to the optimal group of crystal structures and a next generation is output.

Following output of the next generation of crystal structures, the above-described steps are repeated a predetermined number of times for a predetermined number of generations, to output an optimized crystal structure, preferably in Vienna Ab initio Simulation Package (VASP) format describing the crystal structure in terms of unit cell distances to provide dimensions for each atom in the unit cell in each direction and providing coordinates of each atom within the unit cell.

In embodiments, a method for predicting an optimized surface structure following the teachings of U.S. Patent Application Publication No. 2012/0330632 includes inputting characterization information of a chemical structure and input parameters, with the characterization information including a number of atoms, a surface energy and a volume of a unit cell. A first convex hull of a first generation of surface structures is generated from the characterization information using a docking algorithm. Surface structures of the first generation of surface structures include a bulk substrate layer, an adatom layer and a vacuum layer. The first generation of surface structures is restricted based on a convex hull algorithm according to a user-defined chemical potential constraint.

The docking algorithm includes scanning the adatom layer for vacant sites and adding atoms to the vacant sites within the adatom layer based on predetermined conditions that include a coordination number and a distance from adjacent atoms. The docking algorithm includes outputting a configuration of the atoms added to the vacant sites.

The method includes outputting a second convex hull of the first generation of surface structures and optimizing the second convex hull of the first generation of surface structures according to the input parameters. The optimized second convex hull is input into a niching algorithm to select an optimal group of surface structures and a parent group of surface structures based on a fitness function. A child group of surface structures is produced from the parent group of surface structures by applying a variation operator to the adatom layer of the surface structures of the first generation of surface structures. The child group of surface structures is added to the optimal group of surface structures to form a second generation of surface structures. The optimizing through adding steps are repeated for a predetermined number of generations, surface structures having a chemical potential above a user-defined threshold are discarded.

In embodiments of the present disclosure, utilizing the above methods, a series of compounds of the general formula CsFₙ (n=2, 3, 5) are provided which are stable at zero temperature. These compounds are also stable at zero pressure. For example, using CsF₅ as a model, one mole of such compound (228 grams, occupying the volume of about 0.1 liter) contains 2 moles of F₂ gas which, in the free state, would occupy a volume of about 44.8 liters. Thus, storage in the form of CsF₅ is three orders of magnitude more efficient, and much safer, than in the form of pure fluorine gas.

FIG. 1 is a convex hull diagram for the Cs-F system at zero pressure and temperature, showing the formation of numerous (meta)stable fluorine-rich compounds, including CsF₂, CsF₃, CsF₅.

The predicted materials are thermodynamically stable at ambient pressure and temperatures up to their respective decomposition temperatures, from about 250° K for the most fluorine-rich compound, CsF₅, to about 400° K for the least fluorine-rich compound, CsF₂, and their stability increases under pressure.

One may be able to synthesize the compounds from the gas phase at normal pressure, but a more desirable method of synthesis is by the chemical reaction of CsF with excess fluorine at normal or elevated pressure.

The reaction for forming CsF₅

CsF₅=CsF+2F₂ (6)

is thermodynamically unfavorable at zero temperature (the formation energy is approximately 0.18 eV/atom for this chemical reaction), but will be favorable at elevated temperatures, due to the higher entropy over the F₂ molecules.

For example, a procedure for the synthesis of CsF₂ may include the following. CsF₂ is stable at ambient pressure at temperatures below 400° K, and the maximum temperature of its stability increases with pressure.

In general, the synthesis may be conducted as follows:
1 mole (6.023*1023 molecules) of F₂ weighs 38 grams.
1 mole of CsF weighs 151.9 grams.

For the chemical reaction of synthesis of CsF₂:

CsF+½F₂=CsF₂ (7)

To obtain 1 mole of CsF₂ (170.9 grams), one should mix 1 mole of CsF (151.9 grams) and 0.5 moles of F₂ (19 grams). Of course, one can proportionally increase the amounts of reactants to obtain a correspondingly larger amount of product.

In reality, yield Y is always less than 100%, and can be modelled as:

Y=exp(−A/T)exp(−B/t) (8)

where A and B are constants (of dimensionality K and s, respectively), t is time and T is temperature. In a realistic case, at T=400° K and t=1000 seconds, Y=0.5. Increasing time and/or temperature will increase the yield.

In embodiments, the synthesis is conducted at elevated pressures, in embodiments about 2 gigapascal (GPa), to enable higher temperatures for stable production, in embodiments about 600° K, and for longer periods of time, in embodiments about 3000 seconds. This way, one can expect the yield to increase to from about 80% to about 99%.

Analogous considerations apply also to KCl₃. KCl₃ structures may be developed using the methods of U.S. Patent Application Publication No. 2012/0330632. Optimal pressure-temperature conditions of synthesis of KCl₃ are similar to the formation of CsF₂ described above, e.g. at a pressure of about 2 GPa and a temperature of about 600° K.

To synthesize 1 mole of KCl₃ (about 145.44 grams), one can react 1 mole of KCl (about 74.54 grams) and 1 mole of Cl₂ (about 70.90 grams). Here also, one can proportionally increase the amounts of reactants to obtain a correspondingly larger amount of product. The general reaction scheme is as follows:

KCl+Cl₂=KCl₃ (9)

The volumetric density of fluorine or chlorine in the compounds of the present disclosure is extremely high, 3 orders of magnitude higher than for a pure fluorine or chlorine gas at atmospheric pressure, with the compounds possessing reversible absorbed fluorine or chlorine, thus providing favorable advantages for the efficient and safe storage of fluorine and/or chlorine.

Compounds of the present disclosure thus prepared may be stored using any conventional means, including, for example, simple refrigeration.

The present disclosure provides compounds that are very stable and effective storage materials for fluorine and/or chlorine. Compounds of the present disclosure, including CsF₂, CsF₃, and CsF₅, contain polyfluoride anions, and fluorine can be easily recovered from these compounds in the form of F₂ gas by moderate heating.

In embodiments, fluorine and/or chlorine may be recovered from the compounds of the present disclosure by moderate heating to temperatures from about 250° K to about 400° K, in embodiments from about 275° K to about 375° K, and ambient pressure.

The cesium (for the CsFₙ compounds), and the potassium (for the KCl compounds) may be recovered (as CsF for the CsFₙ compound) and then re-utilized by combining with fluorine and/or chlorine to form additional compounds of the present disclosure. The recyclability of these materials make the compounds of the present disclosure both very efficient for their use as storage materials as well as environmentally friendly.

Being very active, fluorine and chlorine easily form stable chemical compounds, from which they can be safely, easily and reversibly extracted.

As F and Cl have a huge range of industrial applications, the present disclosure provides great benefits for the storage of these materials. The compounds herein can reach high storage capacity, stability and reversibility.

While the above description contains many specific details of methods in accordance with this disclosure, these specific details should not be construed as limitations on the scope of the disclosure, but merely as exemplifications of preferred embodiments thereof. Those skilled in the art will envision many other possible variations that are all within the scope and spirit of the disclosure.

What is claimed is:

1. A compound of the formula comprising:
CsFₙ,
wherein n is an integer selected from the group consisting of 2, 3, and 5.

2. A method comprising:
providing a source of CsFₙ, wherein n is an integer selected from the group consisting of 2, 3, and 5
heating the CsFₙ to a temperature from about 250° K to about 400° K;
recovering F as the CsFₙ is heated;
collecting CsF remaining after heating; and
forming CsFₙ by adding additional F to the collected CsF.

3. The method of claim 2, wherein the heating occurs at ambient pressure.

4. A method for forming CsFₙ, the method comprising:
inputting characterization information of a CsFₙ chemical structure and input parameters;
generating a first generation of CsFₙ crystal structures from the characterization information using symmetrical initialization;
optimizing the chemical structure of the first generation of CsFₙ crystal structures according to the input parameters;
inputting the CsFₙ crystal structures of the optimized first generation into a niching algorithm to select an optimal group of CsFₙ crystal structures and a parent group of CsFₙ crystal structures based on a fitness function;
producing a child group of CsFₙ crystal structures from the parent group of CsFₙ crystal structures using a variation operator;
adding the child group of CsFₙ crystal structures to the optimal group of CsFₙ crystal structures to form a next generation of CsFₙ crystal structures; and
repeating the optimizing through adding steps for a predetermined number of generations,
wherein n is an integer selected from the group consisting of 2, 3, and 5.

5. A method for predicting an optimized surface structure of CsFₙ crystal structures, the method comprising:
inputting characterization information of a CsFₙ crystal structure and input parameters;
generating a first convex hull of a first generation of surface structures of the CsFₙ crystal structure from characterization information using a docking algorithm;
restricting the first generation of surface structures of the CsFₙ crystal structure based on a convex hull algorithm according to a user-defined chemical potential constraint and outputting a second convex hull of the first generation of surface structures of the CsFₙ crystal structure;
optimizing the second convex hull of the first generation of surface structures of the CsFₙ crystal structure according to the input parameters;
inputting the optimized second convex hull into a niching algorithm to select an optimal group of surface structures of the CsFₙ crystal structure and a parent group of surface structures of the CsFₙ crystal structure based on a fitness function;
producing a child group of surface structures of the CsFₙ crystal structure from the parent group of surface structures of the CsFₙ crystal structure by applying a variation operator to an adatom layer of the surface structure of the first generation;
adding the child group of surface structures of the CsFₙ crystal structure to the optimal group of surface structures of the CsFₙ crystal structure to form a second generation of surface structures of the CsFₙ crystal structure; and
repeating the optimizing through adding steps for a predetermined number of generations,
wherein n is an integer selected from the group consisting of 2, 3, and 5.
